(19) United States
(12) Patent Application Publication
(10) Pub. No.: US 2026/0254125 A1
(43) Pub. Date: Aug. 27, 2026

(54) METASURFACE FLAT LENS-TYPE BEAMFORMING ANTENNA FOR RADARS AND COMMUNICATION, CAPABLE OF VARYING ELECTROMAGNETIC WAVE BEAM POINTING ANGLE BY SELECTING ONE FROM ELECTROMAGNETIC WAVE SOURCES, AND REQUIRING NO CHIPSET ACTIVE PHASE SHIFTERS

(71) Applicant: INCHEON UNIVERSITY INDUSTRY ACADEMIC COOPERATION FOUNDATION, Incheon (KR)

(72) Inventors: Sungtek KAHNG, Incheon (KR); Yejune SEO, Incheon (KR); Jiyeon JANG, Anyang-si, Gyeonggi-do (KR)

(21) Appl. No.: 18/861,867

(22) PCT Filed: Oct. 5, 2023
(86) PCT No.: PCT/KR2023/015286

§ 371 Date: Oct. 30, 2024

(30) Foreign Application Priority Data
Jul. 31, 2023 (KR) 10-2023-0099651

(51) Int. Cl. H01Q 15/02; G01S 7/00; H01Q 3/24; H01Q 9/04; H01Q 15/00

(52) U.S. Cl. CPC H01Q 15/02; H01Q 3/247; H01Q 9/0407; H01Q 15/0086; G01S 7/006

(57) ABSTRACT

The present disclosure suggests: a primary device that changes a steering angle of a beam by repositioning radiation sources made of purely passive components and passing the beam through a metamaterial flat lens; components or the entirety of a device in which patches are arranged according to positions of radiation sources without using a power divider, and when a patch is selected through an RF switch, an electromagnetic wave is incident to a metamaterial lens, and by which a phase compensation value is implemented at each point of the metamaterial lens using a combination structure of metal circular patches within a metal ring, ensuring robust and sensitive resonant characteristics that adapt flexibly to changes in incidence direction, frequency signals, or process errors, thereby preventing any negative outcomes; and an operation method using a switch, so as to provide a solution that addresses problems of conventional beam steering antennas.

### TECHNICAL FIELD

The present disclosure relates to an array antenna technology for a radar system, an array antenna technology for a satellite, a millimetre-wave band array antenna technology for a 5G mobile repeater, a sub-terahertz band array antenna technology for a 6G mobile repeater, an array antenna technology for a high-frequency transmitter and receiver for an autonomous vehicle, a high-frequency transmitter and receiver array antenna technology for V2X, and a high-frequency wireless power transfer array antenna technology, and specifically, to a metasurface flat lens-type beamforming antenna for radars and communication, capable of adjusting an electromagnetic wave beam pointing angle by selecting an electromagnetic wave source and requiring no chipset active phase shifters.

### BACKGROUND ART

Beamforming and beam-steering antenna technologies form the core of radar systems, which are critical for maintaining connections between wireless communication devices while tracking a moving receiver without interruption and indispensable for preventing vehicle collisions and avoiding collision with an object in a flight path of an unmanned aerial vehicle (UAV) and an urban air mobility (UAM).

The beamforming technology which is widely cited along with 5G communication service promotion refers to a function for forming and adjusting a beam, and has the same meaning as adjusting an angle of a main beam through a combination of radiated waves, long-distance constructive interference, RF elements, and digital signal processing control blocks. The change in the main beam direction in a beamforming array antenna is caused by a difference in phases provided to radiating elements (arrangement of elements) and is determined by the outputs of RF phase shifters for radiating elements.

Most beamforming antennas, such as an AESA radar of a fighter plane and a 5G beamforming transceiver, include expensive active phase shifters having a semiconductor chip circuitry(chipset) and connected to each of radiating elements and thus have economic disadvantages in that when antenna gain and beam-steering range increase, the size of the array and the number of radiating elements rapidly grow, and the number of active phase shifters increases, requiring enormous costs. Furthermore, the element is active and thus large power consumption is inevitable for operation thereof. The phase shifters are active elements acquired through a semiconductor process and as many phase shifters are needed as radiating elements.

### DISCLOSURE OF INVENTION

### Technical Problems

An aspect of the present disclosure provides a metasurface flat lens-type beamforming antenna for radars and communication, capable of adjusting an electromagnetic wave beam pointing angle by selecting an electromagnetic wave source and requiring no chipset active phase shifters, wherein compared to a conventional beamforming antenna or beam-steering antenna in which active phase shifters are connected to each radiating element, leading to high development and operational costs, increased power consumption, and added weight and which requires the phase shifters equal to the square of the number of radiating elements when attaching the active phase shifter to each radiating element, the antenna significantly reduces manufacturing costs and power consumption while enabling the steering of high-directional electromagnetic energy to track moving objects, as required in radar and 5G and 6G mobile communications and in addition to the aforementioned practical values, the antenna will offer a novel technology that selects only one radiation source from an array and employs a meta-material structured lens suitable for the wavefront thereof, and causes an electromagnetic wave to be incident to the lens, rather than a traditional method of concurrently and simultaneously supplying phase differences to multiple radiation sources.

Furthermore, an aspect of the present disclosure provides a metamaterial flat lens used in the metasurface flat lens-type beamforming antenna for radars and communication, capable of adjusting an electromagnetic wave beam pointing angle by selecting an electromagnetic wave source and requiring no chipset active phase shifters.

Furthermore, an aspect of the present disclosure provides a unit cell structure for the meta-material flat lens used in the metasurface flat lens-type beamforming antenna for radars and communication, capable of adjusting an electromagnetic wave beam pointing angle by selecting an electromagnetic wave source and requiring no chipset active phase shifters.

### Solution to the Problems

To address the aforementioned task, the metasurface flat lens-type beamforming antenna for radars and communication, capable of adjusting an electromagnetic wave beam pointing angle by selecting an electromagnetic wave source and requiring no chipset active phase shifters according to an embodiment of the present disclosure includes:
a radiating part including multiple radiating patches arranged in one dimension and spaced a predetermined distance apart from each other; and
a metamaterial flat lens which is disposed spaced a predetermined distance apart from the radiation part and on which single-layer or multi-layer unit cell structures configured to compensate for a phase are arranged to match a phase compensation distribution for a high gain and steering of an incident wave having been radiated from just one of the multiple radiating patches.

With respect to the metasurface flat lens-type beamforming antenna for radars and communication, capable of adjusting an electromagnetic wave beam pointing angle by selecting an electromagnetic wave source and requiring no chipset active phase shifters according to an embodiment of the present disclosure, the unit cell structures may include:
a metal ring; and
a modified circular patch disposed inside the metal ring and spaced a predetermined distance apart from the metal ring.

Furthermore, with respect to the metasurface flat lens-type beamforming antenna for radars and communication, capable of adjusting an electromagnetic wave beam pointing angle by selecting an electromagnetic wave source and requiring no chipset active phase shifters according to an embodiment of the present disclosure, the modified circular patch may include:
a first capacitance adjustment part acquired by making a hole at the central part of the circular patch; and
a second capacitance adjustment part acquired by making notches on the top, bottom, left, and right sides as the outer circumferential part of the circular patch,
wherein the circular patch is configured to have a point symmetric shape.

Furthermore, with respect to the metasurface flat lens-type beamforming antenna for radars and communication, capable of adjusting an electromagnetic wave beam pointing angle by selecting an electromagnetic wave source and requiring no chipset active phase shifters according to an embodiment of the present disclosure,
a phase of an incident electromagnetic wave is compensated for by a combination of an inductance of the metal ring and a capacitance of the circular patch, and
when the incident electromagnetic wave passes through each layer of a multi-layer unit cell structure, the phase required for an individual cell is obtained.

Furthermore, with respect to the metasurface flat lens-type beamforming antenna for radars and communication, capable of adjusting an electromagnetic wave beam pointing angle by selecting an electromagnetic wave source and requiring no chipset active phase shifters according to an embodiment of the present disclosure, the phase to be compensated for is be determined according to at least one of a diameter of the circular patch and a gap corresponding to a separation distance between the metal ring and the circular patch.

Furthermore, the metasurface flat lens-type beamforming antenna for radars and communication, capable of adjusting an electromagnetic wave beam pointing angle by selecting an electromagnetic wave source and requiring no chipset active phase shifters according to an embodiment of the present disclosure, may further include a switch configured to provide an incident electromagnetic wave to one of the multiple radiating patches.

Furthermore, the metasurface flat lens-type beamforming antenna for radars and communication, capable of adjusting an electromagnetic wave beam pointing angle by selecting an electromagnetic wave source and requiring no chipset active phase shifters according to an embodiment of the present disclosure, may further include a switch controller for the switch.

Furthermore, with respect to the metasurface flat lens-type beamforming antenna for radars and communication, capable of adjusting an electromagnetic wave beam pointing angle by selecting an electromagnetic wave source and requiring no chipset active phase shifters according to an embodiment of the present disclosure, the unit cell structure configured to have multiple layers may be configured by stacking multiple single-layer unit cells having an identical structure of multiple layers.

To address the aforementioned task, a metamaterial flat lens according to an embodiment of the present disclosure may include single-layer or multi-layer unit cell structures configured to compensate for a phase for a high gain and steering of an incident wave,
wherein the single-layer or multi-layer unit cell structures is arranged to meet the required phase distribution on the plane of interest.

With respect to the metamaterial flat lens according to an embodiment of the present disclosure, the unit cell structures may include:
a metal ring; and
a modified circular patch disposed inside the metal ring and spaced a predetermined distance apart from the metal ring.

Furthermore, with respect to the metamaterial flat lens according to an embodiment of the present disclosure, the modified circular patch may include:
a first capacitance adjustment part acquired by making a hole at the central part of the circular patch; and
a second capacitance adjustment part acquired by making notches on the top, bottom, left, and right sides as the outer circumferential part of the circular patch,
wherein the circular patch is configured to have a point symmetric shape.

Furthermore, with respect to the metamaterial flat lens according to an embodiment of the present disclosure, a phase of an incident electromagnetic wave is compensated for by a combination of an inductance of the metal ring and a capacitance of the circular patch, and
when the incident electromagnetic wave passes through each layer of a multi-layer unit cell structure, the phase required for an individual cell is obtained.

Furthermore, with respect to the metamaterial flat lens according to an embodiment of the present disclosure, the phase to be compensated for is determined according to at least one of a diameter of the circular patch and a gap corresponding to a separation distance between the metal ring and the circular patch.

Furthermore, with respect to the metamaterial flat lens according to an embodiment of the present disclosure, the multi-layer unit cell structures may be configured by stacking multiple single-layer unit cells having an identical structure of multiple layers.

A unit cell structure for the metamaterial flat lens according to an embodiment of the present disclosure to address the aforementioned task may correspond to a unit cell structure for a metamaterial flat lens for a high gain and steering of an incident wave, and
the unit cell structure may be configured as a single layer or multiple layers and compensate for a phase for a high gain and steering of an incident wave.

With respect to the unit cell structure for the metamaterial flat lens according to an embodiment of the present disclosure, the unit cell structure may include:
a metal ring; and
a modified circular patch disposed inside the metal ring and spaced a predetermined distance apart from the metal ring.

Furthermore, with respect to the unit cell structure for the metamaterial flat lens according to an embodiment of the present disclosure, the modified circular patch may include:
a first capacitance adjustment part acquired by making a hole at the central part of the circular patch; and
a second capacitance adjustment part acquired by making notches on the top, bottom, left, and right sides as the outer circumferential part of the circular patch,
wherein the circular patch is configured to have a point symmetric shape.

Furthermore, with respect to the unit cell structure for the metamaterial flat lens according to an embodiment of the present disclosure, a phase of an incident electromagnetic wave is compensated for by a combination of an inductance of the metal ring and a capacitance of the circular patch, and
when the incident electromagnetic wave passes through each layer of a multi-layer unit cell structure, the phase required for an individual cell is obtained.

Furthermore, with respect to the unit cell structure for the metamaterial flat lens according to an embodiment of the present disclosure, the phase to be compensated for-is determined according to at least one of a diameter of the circular patch and a gap corresponding to a separation distance between the metal ring and the circular patch.

Furthermore, with respect to the unit cell structure for the metamaterial flat lens according to an embodiment of the present disclosure, the unit cell structure configured to have multiple layers may be configured
by stacking multiple single-layer unit cells having an identical structure of multiple layers.

### Advantageous Effects of Invention

Compared to a conventional beamforming antenna or beam-steering antenna in which active phase shifters are connected to each radiating element, leading to high development and operational costs, increased power consumption, and added weight and which requires the phase shifters equal to the square of the number of radiating elements when attaching the active phase shifter to each radiating element, the metasurface flat lens-type beamforming antenna for radars and communication, capable of adjusting an electromagnetic wave beam pointing angle by selecting an electromagnetic wave source and requiring no chipset active phase shifters according to an embodiment of the present disclosure will significantly reduce manufacturing costs and power consumption while enabling the steering of high-directional electromagnetic energy to track moving objects, as required in radar and 5G and 6G mobile communications and in addition to the aforementioned practical values, will offer a novel technology that selects only one radiation source from an array and employs a meta-material structured lens suitable for the wavefront thereof, and let an electromagnetic wave incident to the lens, rather than a traditional method of concurrently and simultaneously supplying phase differences to multiple radiation sources, so as to have significant advantages not only in terms of technological innovation but also cost reduction.

### BRIEF DESCRIPTION OF DRAWINGS

FIGS. 1A to 1D are conceptional views illustrating a structure and operation of a conventional beamforming array antenna having problems of power consumption, heat generation, and costs.

FIG. 2 is a conceptional view illustrating a metasurface flat lens-type beamforming antenna for radars and communication, capable of adjusting an electromagnetic wave beam pointing angle by selecting an electromagnetic wave source and requiring no chipset active phase shifters, in which patches configured to operate as radiation sources for each steering angle are arranged in an one-dimensional array and then a patch with the number corresponding to a target steering angle is selected using an RF switch so as to direct an RF signal to a metamaterial flat lens positioned above the patches and increase a gain thereof to be emitted toward a receiver.

FIG. 3 is a conceptional view illustrating determination of a focal length of an optical lens to allow an electromagnetic wave to have a high gain in a specific direction after passing through a metamaterial surface in order to determine the whole area of a metamaterial planar surface and a distance to a patch element in the structure of the present disclosure in FIG. 2, which selects only one element and applies an RF signal thereto.

FIGS. 4A and 4B are most basic views illustrating a metamaterial lens, showing that when a horn antenna, commonly selected as a radiation source, generates and direct an electromagnetic wave upwards, a metamaterial structure adjusts a phase of each point where a ray enters, generating an effect similar to inputting a phase difference into elements of an array antenna to generate a beam and adjust a direction of the beam.

FIG. 4C, together with the three-dimensional concept view of FIGS. 4A and 4B, illustrates the phase difference distribution or phase compensation distribution configured to change the surface phase distribution of an electromagnetic wave generated by a radiation source and transferred to the bottom of a metamaterial surface to a phase required for beam steering and gain increase. The phase compensation distribution is changed depending on a type of a radiation source, a distance and direction between an aperture of a radiation source from which the wavefront of the electromagnetic wave propagates and the observation plane, and a final radiation pattern after passing through a metamaterial surface, that is, an expected steering angle and a gain increase amount. For physical implementation, a metal pattern is applied to a PCB substrate, and pixels having a continuous phase compensation distribution and having a discretized grid shape due to precision limitations of a PCB etching process are configured to implement the phase required for each unit segment.

FIG. 5 is a flowchart illustrating a design procedure of a proposed device.

FIG. 6A illustrates a representative appearance of a radiating element of a device according to a new concept suggested by the present disclosure, the device determining a beam steering angle of a transmitarray antenna by selecting one radiation source from an array of radiation sources. FIG. 6B illustrates return loss (S11), and FIG. 6C illustrates the beam-pattern observed on different Φ-planes.

FIGS. 7A and 7B illustrate one radiation source of FIG. 6A arranged in one dimension. It is important to note that this array is not a conventional array antenna, that is, a general array antenna including a power divider on a surface together with patches or on a lower surface thereof, or array antenna elements having a phase difference relationship based on a steering angle input, but radiation sources operating independently. FIG. 7C illustrates return loss (S11).

FIG. 8A illustrates a discretization of phase compensation distribution configured to compensate for a phase of a wide-width radiation wave of a radiation source, observed on the bottom of a metamaterial structure for high gain and beam steering. FIG. 8B illustrates a structure of one layer of unit cell structure and FIG. 8C illustrates a multi-layer unit cell structure configured in three layers. This structure allows for determination of the necessary phase for each unit cell, that is, pixel, of the metamaterial structure, increases design flexibility through increasing design variables by employing a new structure that combines a modified circular patch within a metal ring and replicates it throughout the three layers, and allows for the desired phase per pixel to be achieved with fewer layers through concurrent operation of L and C by combining an inductance of the ring and a capacitance of the circular patch, showing an advantage in preventing millimeter-wave signal attenuation and bandwidth narrowing. In addition, the unit cell structure has a symmetrical structure that is less susceptible to polarization in both transmission and reception wave and allows good transmission and reception. By adjusting geometric parameters such as a diameter of the modified circular patch, a size of the ring, a gap corresponding to a distance between the modified circular patch and the ring, and a filling ratio corresponding to an area ratio of the circular patch to the ring, a magnitude of a transmission coefficient (a transmission coefficient in a state in which the bottom of a pixel is configured as an input port and the top of the pixel is configured as an output port, that is, S21) is maximized to primarily increase the phase, and as passing through each layer, the phase reaches the desired phase for a single pixel. FIG. 8D illustrates transmission loss, and FIG. 8E illustrates a transmission phase. FIG. 8F illustrates the relationship between a diameter R1 of a circular patch, which is a geometric variable, and the transmission coefficient on that pixel, that is, a transmission coefficient phase profile. Dimensions are determined through this graph. FIG. 8G illustrates a metamaterial flat lens implemented to have a specialized pattern, such as a checkerboard or compound eye of a dragonfly by arranging the pixel structures.

FIGS. 9A and 9B illustrate integration of a metamaterial structure lens having a holographic surface shown in FIG. 8G with a radiation source array layer.

FIGS. 10A to 10I are views illustrating electromagnetic characteristics of the structure in which the metamaterial structure lens is integrated with the radiation source array layer shown in FIGS. 9A and 9B and advantages of the present disclosure. Port 1 denotes that patch 1 is selected, Port 2 denotes that patch 2 is selected, . . . , and Port 9 denotes that patch 9 is selected. As shown in FIG. 10A, it is identified that when Port 1 is selected, a radiation beam directs to the right, as shown in a three-dimensional radiation pattern and a two-dimensional rectangular plot of the radiation pattern. Furthermore, as shown in FIGS. 10B to 10I, by selecting a radiation source from Port 2 to Port 9, a direction of a beam changes while maintaining high gain characteristics. FIG. 10J is a view illustrating a one-dimensional plot of radiation pattern with the changing angle.

### BEST MODE FOR CARRYING OUT THE INVENTION

The objectives, specific advantages, and novel features of the present disclosure will become more apparent from the following detailed description and preferred embodiments taken in conjunction with the accompanying drawings.

Furthermore, the terms and words used in the specification and claims should not be interpreted in their conventional or dictionary meanings. Instead, they should be understood in the context of the technical spirit of the disclosure, based on the principle that the inventor can define the concepts of the terms appropriately to best describe the disclosure.

It should be noted that in assigning reference numbers to the components in the various drawings of the present specification, the same numbers are used for identical components, even if they are depicted in different drawings.

As used herein, terms as “first”, “second”, “one surface”, “the other surface”, and the like may be used to simply distinguish a corresponding component from another, and are not intended to limit the components to the particular meanings of the terms.

In the following description of the disclosure, a detailed description of the related prior art incorporated herein will be omitted when it is determined that the description may make the subject matter of embodiments disclosed in the disclosure unclear. The accompanying drawings are only for easy understanding of the embodiments disclosed in the present specification, and the technical ideas disclosed in the present specification are not limited by the accompanying drawings and it should be understood to include all modifications, equivalents and substitutes included in the spirit and scope of the present disclosure.

Hereinafter, a preferred embodiment of the present disclosure will be described in detail with reference to accompanying drawings.

The present disclosure provides a technology that uses an array of radiating elements, instead of an array antenna, and selects only one element at a time to provide an electromagnetic wave, a metamaterial structure, a metamaterial lens, a beamforming antenna, a beam-steering antenna, surface phase distribution, and a phase compensation structure.

The present disclosure enables phase changes that could not be achieved with the traditional passive method, by utilizing a new passive method. The present disclosure provides a device which selects one radiation source, paired with a pointing angle, from electromagnetic wave sources with input terminals arranged for respective beam angles in an one dimension through a low-power RF switch and causes an electromagnetic wave thereof to pass through a metamaterial flat lens located above and suitable for beam steering and to be propagated in a high-gain wireless energy form in a selected direction for a long distance.

The present disclosure introduces a new generation of low-power consumption beamforming array antenna that will minimize power consumption in a phase shifter and connection transmission lines by using only switches and passive components, avoiding the use of expensive active phase shifters that has become costly due to the addition of a non-essential amplifier for each radiating element.

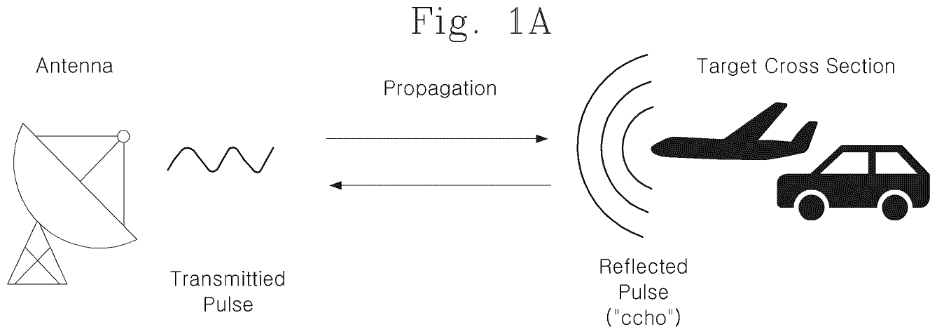

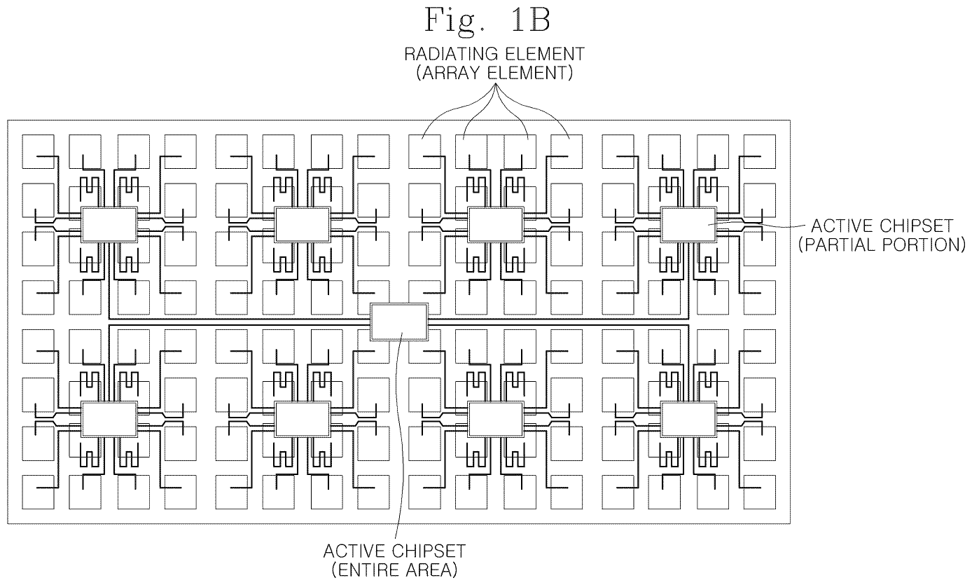

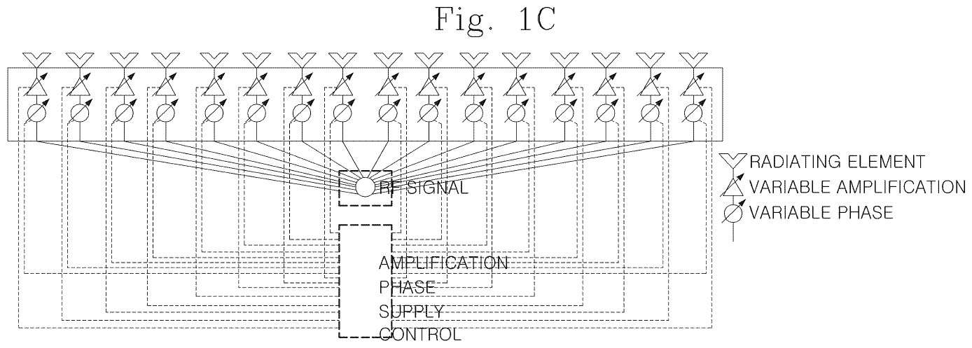

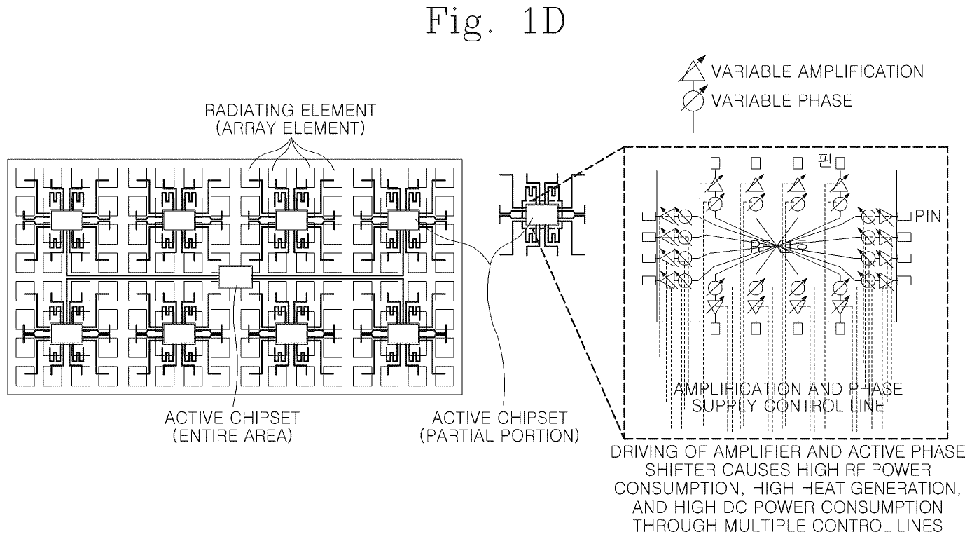

FIG. 1A illustrates a general radar system which receives a reflected wave among scattered waves when an electromagnetic wave emitted from an antenna hits an object like an airplane. An antenna having a large volume is used due to a high output with very high input power and a free space with low electromagnetic wave loss, unlike a wall.

Problems in development and operation of a conventional beamforming antenna as shown in FIGS. 1B to 1D begin when an expensive active phase shifter in a chip form (chipset) is combined to each of all radiating elements. The beamforming chipset has variable amplifiers together with variable phase shifters therein, as a product of the semiconductor process, amplifies control DC power and an RF signal, resulting in high RF power consumption, so that even a single element is expensive and consumes a relatively high minimum amount of power.

Furthermore, as the requirement for electromagnetic radiation gain and beamwidth becomes tougher, the size of an array and the number of radiating elements also rapidly increase and the number of active phase shifters also increases, leading to higher power consumption, weight, and cost, which negatively impact the overall array antenna system. Despite recognizing the aforementioned problems, when beamforming and beam steering are required, even alternatives like faster mechanical rotation, multi-channel receivers, and the multiplexed use of leaky-wave antennas with frequency scanning resulted in reduced speed and accuracy, ultimately leading to costs similar to those of using active phase shifter chipsets. To solve the problem, a passive method that will reduce weight, heat, and cost is necessary, but this is not achievable with conventional passive methods, making the development of a new approach essential.

The change in the main beam direction in a beamforming array antenna, which is critical in 5G millimeter-wave band devices and moving object detection radars, is caused by a difference in phases provided to radiating elements (arrangement elements) and is determined by the output of an RF phase shifter for each radiating element. The most significant problem is that, as shown in FIGS. 1B to 1D illustrating the inside of the 5G beamforming transceiver and the AESA radar, beamforming antennas include expensive active phase shifters having a semiconductive chip shape (chipset) and connected to each of radiating elements and thus require enormous costs in that when the requirements for electromagnetic radiation gain and beam width become tougher, the size of the array and the number of radiating elements rapidly increase, and the number of active phase shifters increases.

Furthermore, combination of amplifiers, which are not essential for all of the radiating elements, and active phase shifters, which provide a large phase shift when a large phase shift is not needed, inevitably adds weight. In addition to the cost high, the element is of the active type and consume considerable RF power and DC power (for amplifier biasing and control). The objective of the present disclosure is to achieve the purpose of beam steering while reducing the high cost, power consumption, weight gain, and unnecessary input of high-end resources.

To address the aforementioned problems, the present disclosure provides a method based on a new concept, in which when electromagnetic wave radiation source patches predetermined for each pointing angle are arranged and a desired source for a pointing angle is selected using an RF switch so as to direct an electromagnetic wave upwards, a metamaterial flat lens having been designed in consideration of incident angles compensates for a phase of a incident wave and amplifies a gain thereof to direct the electromagnetic wave in the selected pointing angle.

Although it looks similar to an array antenna in some aspects, unlike array antennas, which concurrently and simultaneously apply power to elements like patches, the method fundamentally differs from array antennas in that only one of arranged elements is selected and the problems described above are addressed with corresponding solutions as follows.

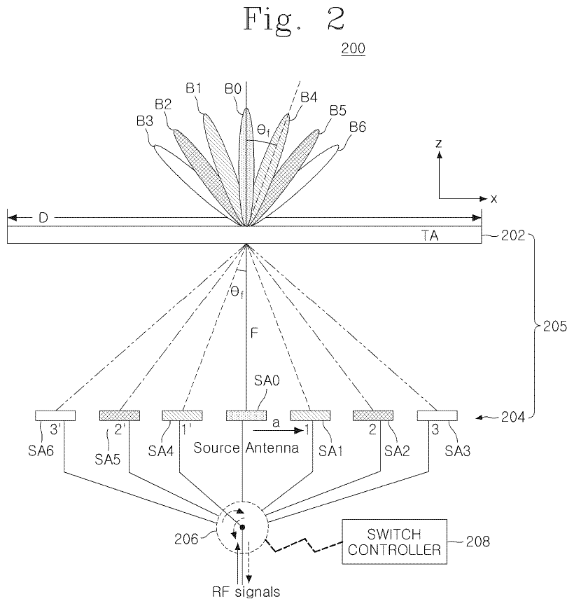

FIG. 2 is a view illustrating a metasurface flat lens-type beamforming antenna for radars and communication, capable of adjusting an electromagnetic wave beam pointing angle by selecting an electromagnetic wave source and requiring no chipset active phase shifters according to an embodiment of the present disclosure.

Referring to FIG. 2, the beamforming antenna 200 with a metasurface flat lens for radars and communication, capable of adjusting an electromagnetic wave beam pointing angle by selecting an electromagnetic wave source and requiring no chipset active phase shifters according to an embodiment of the present disclosure may include: a radiation part 204 including multiple radiating patches SA0 to SA6 arranged in one dimension and spaced a predetermined distance apart from each other; and a metamaterial flat lens 202 which is disposed spaced a predetermined distance apart from the radiation part 204 and on which single-layer or multi-layer unit cell structures configured to compensate for a phase are arranged to match a phase compensation distribution for a high gain and steering of an incident wave having been radiated from one of the multiple radiating patches SA0 to SA6.

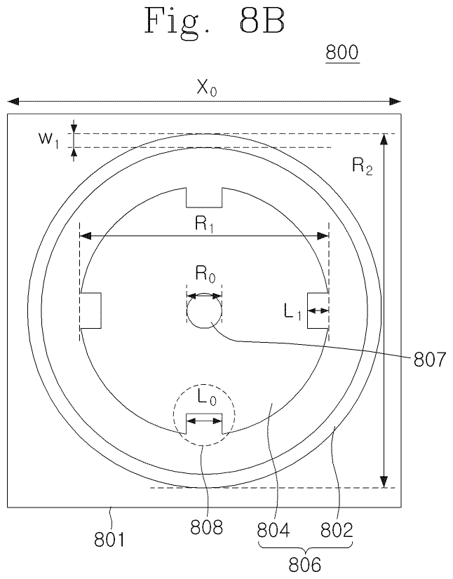

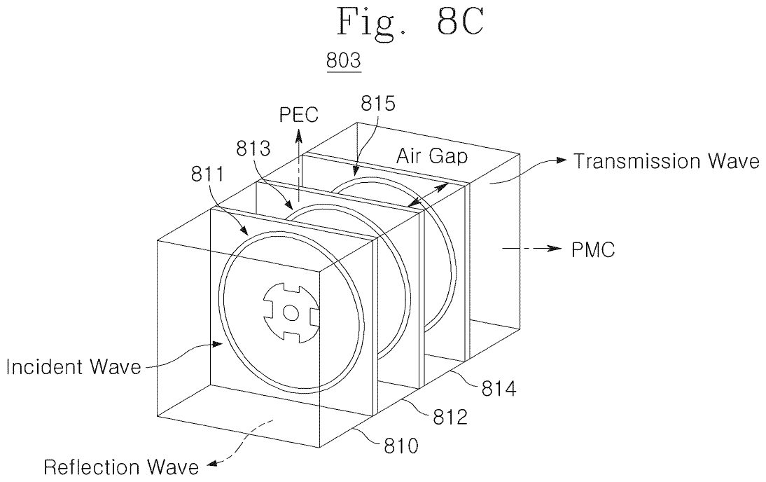

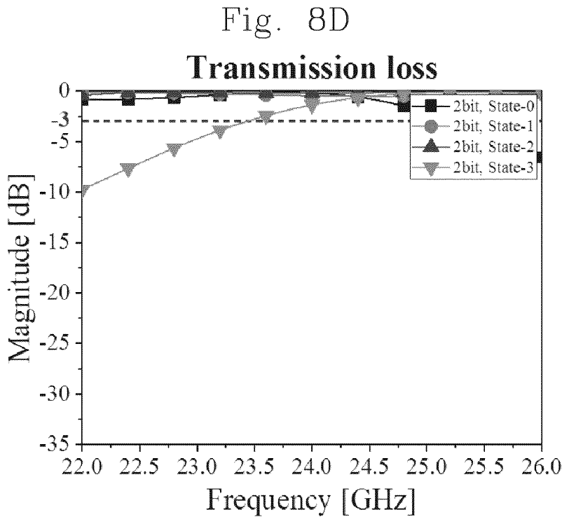

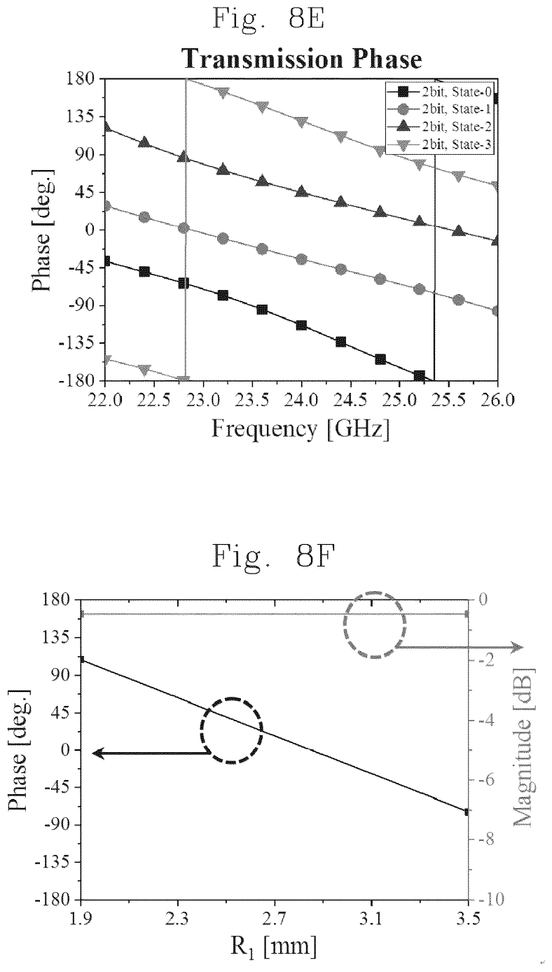

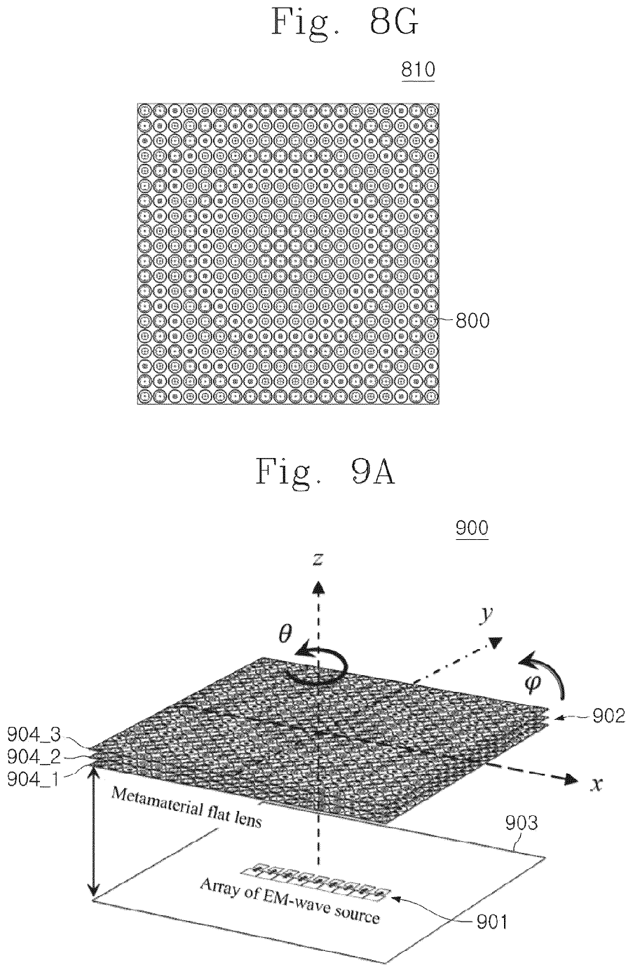

As shown in FIG. 8B, a unit cell structure 800 may include a metal ring 802 and a modified circular patch 804 disposed spaced a predetermined distance apart from the metal ring 802.

Referring to FIG. 8B, the modified circular patch 804 may include a first capacitance adjustment part 807 acquired by making a hole at the circular patch 804 in a circular shape and a second capacitance adjustment part 808 acquired by making notches on the top, bottom, left, and right sides as the outer circumferential part of the circular patch 804.

A combination of an inductance of the metal ring 802 and a capacitance of the circular patch 804 allows for compensation of a phase of an incident electromagnetic wave, and as shown in FIG. 8C, when the incident electromagnetic wave passes through each layer of a multi-layer unit cell structure 803 configured to have three layers 810, 812, and 814, the phase required for an individual cell structure 803 is obtained. The multi-layer unit cell structure 803 configured to have multiple layers may be configured by stacking multiple single-layer unit cells 810, 812, and 814 having an identical structure of multiple layers.

The phase to be compensated for is determined according to at least one of a diameter R1 of the circular patch 804 and a gap corresponding to a separation distance between the metal ring 802 and the circular patch 804.

Referring to FIG. 2, the beamforming antenna 200 with a metasurface flat lens for radars and communication, capable of adjusting an electromagnetic wave beam pointing angle by selecting an electromagnetic wave source and requiring no chipset active phase shifters according to an embodiment of the present disclosure, may further include an RF switch 206 configured to provide an RF signal corresponding to an incident electromagnetic wave to one of the multiple radiating patches SA0 to SA6 and a switch controller 208 configured to control operation of the RF switch 206.

Operations of the beamforming antenna 200 with a metasurface flat lens for radars and communication, capable of adjusting an electromagnetic wave beam pointing angle by selecting an electromagnetic wave source and requiring no chipset active phase shifters according to an embodiment of the present disclosure described above will be explained in detail below with reference to FIGS. 2 to 10.

FIG. 2 illustrates the beamforming antenna 200 with a metasurface flat lens for radars and communication, capable of adjusting an electromagnetic wave beam pointing angle by selecting an electromagnetic wave source and requiring no chipset active phase shifters according to an embodiment of the present disclosure, and shows a concept that instead of using an expensive chipset active phase shifter for a radiating element of an array antenna, the radiating patches SA0 to SA6 configured to operate as radiation sources are arranged in an one-dimensional array for each steering angle and then a patch with a number corresponding to a target steering angle is selected using the RF switch 206 by controlling of the switch controller 208 so that an input RF signal is radiated from the radiating patch, an electromagnetic wave having been radiated from the selected radiating patch direct is incident to the metamaterial flat lens 202 positioned above the patch, and the metamaterial flat lens 202 increases a gain of an incident wave to be emitted toward a receiver. A position of a radiating patch SA0 to SA6 corresponding to a primary radiation wave source and the metamaterial flat lens 202 corresponding to a secondary source configured to focus the electromagnetic wave to a desired steering angle according to the radiating patch need to be prepared simultaneously.

For example, when intending to radiate an incident RF signal in a form of a beam B4 corresponding to a target steering angle Of, the switch controller 208 will control the RF switch 206 to select a radiating patch SA4 so that the RF signal is provided to one radiating patch SA4 among the radiating patches SA0 to SA6. In case that the radiating patch SA4 is selected through the RF switch 206, the RF signal is applied to the radiating patch SA4 selected by the RF switch 206 and an electromagnetic wave radiated from the selected radiating patch SA4 is incident to the metamaterial flat lens 202. The metamaterial flat lens 202 changes the angle of the incident wave radiated from the radiating patch SA4 and compensates for the phase thereof to enhance the gain and steering of the phase distribution of the incident wavefront, so as to output a beam B4.

As such, in the beamforming antenna 200 with a metasurface flat lens for radars and communication, capable of adjusting an electromagnetic wave beam pointing angle by selecting an electromagnetic wave source and requiring no chipset active phase shifters according to an embodiment of the present disclosure, the switch controller 208 controls the RF switch 206 to select the radiating patch SA4 to cause the RF signal to be provided to only one of the radiating patches SA0 to SA6, the RF signal is applied to the radiating patch SA4 selected by the RF switch 206 to cause the electromagnetic wave radiated from the selected patch SA4 to be incident on the metasurface lens 202, and the metamaterial lens 202 increases the gain of the incident electromagnetic wave and modifies same to have the required phase to output the electromagnetic wave, so that there is no need for a power divider to be connected and as the RF signal is applied to only one of the radiating patches at a time, unnecessary interference may not be caused even if the patches are placed close together, thus allowing the patches to be arranged closer to each other.

### MODE FOR CARRYING OUT THE INVENTION

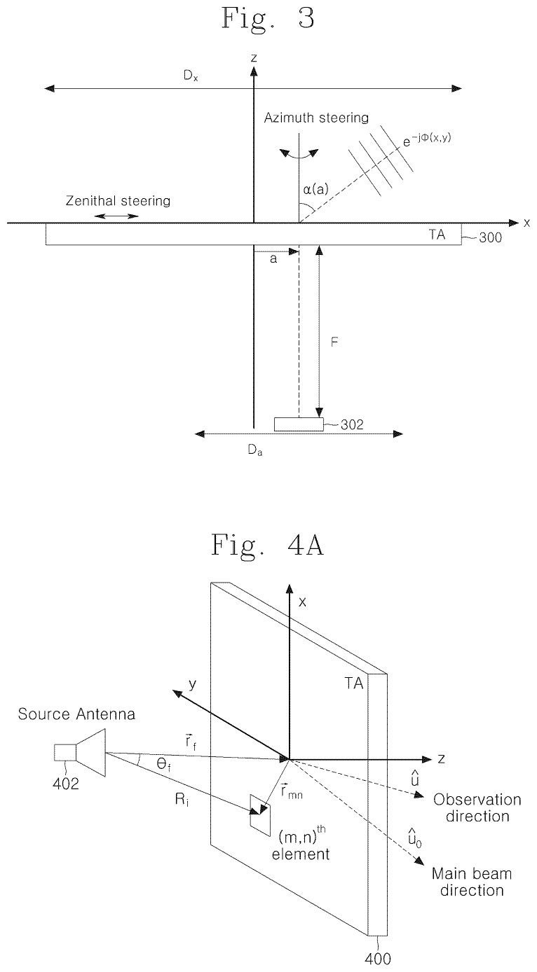

FIG. 3 shows an application of a method for calculating a focal length of an optical lens to allow an electromagnetic wave to have a high gain in a specific direction after passing through a metamaterial surface so as to determine a whole area of a metamaterial flat lens 300 and a distance to a patch element 302 in the structure of the present disclosure in FIG. 2, which selects only one element 302 and applies an RF signal thereto unlike array antennas.

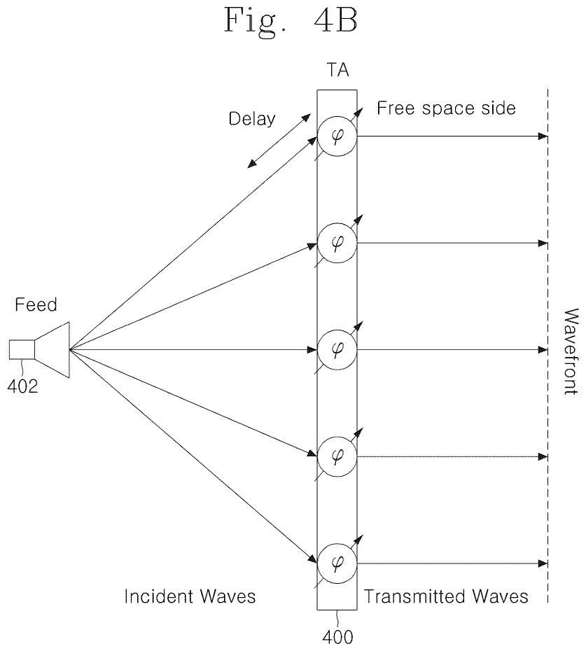

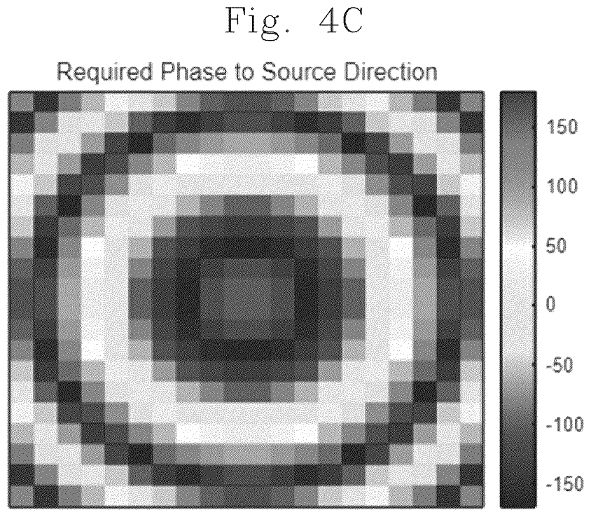

FIGS. 4A and 4B are most basic views illustrating a metamaterial flat lens 400, showing that when a horn antenna 402, commonly selected as a radiation source, generates and directs an electromagnetic wave upwards as a primary source, a metamaterial structure 400 adjusts a phase of each point where a ray enters, generating an effect similar to inputting a phase difference into elements of an array antenna to generate a beam and adjust a direction of the beam.

Considering the angle of incidence and the phase of the incident electromagnetic wave as the input and the electromagnetic wave emitted from the metamaterial structure 400 as the output, the adjusting of the phase at the point where the ray enters means that the surface must function as a phase compensation surface that increases a gain of the output and allows the output to tilt toward the desired angle. Currently, the horn antenna 402 is illustrated for conceptual purposes, but in the present disclosure, a patch antenna is used as the primary element, which is easily manufactured by PCB processes and will be manufactured at a lower cost and more effectively than the horn antenna.

FIG. 4C, together with the three-dimensional concept view of FIGS. 4A and 4B, illustrates phase difference distribution or phase compensation distribution configured to change surface phase distribution of an electromagnetic wave generated by a radiation source and transferred to the bottom surface of a metamaterial surface to a phase required for beam steering and gain increase. The phase compensation distribution is changed depending on a type of a radiation source, a distance and direction between an aperture of a radiation source from which the wavefront of an electromagnetic wave propagates and an observation plane, and the final radiation pattern after passing through a metamaterial surface, that is, an expected steering angle and a gain increase amount. For physical implementation, a metal pattern is applied to a PCB substrate, and pixels having a continuous phase compensation distribution and having a discretized grid shape due to precision limitations of a PCB etching process are configured to implement the phase required for each unit segment.

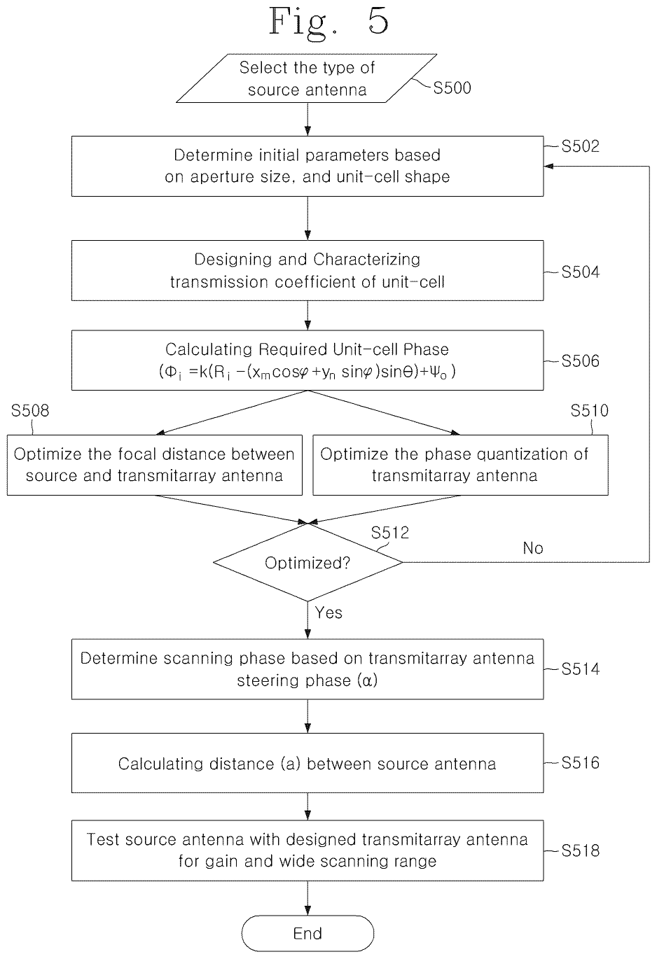

FIG. 5 illustrates a design procedure of a proposed device as follows. First, in operation S500, a type of a radiation source is selected. Second, in operation S502, initial design variables, such as a size of an aperture of a metamaterial surface, a shape of a unit structure (pixel), are determined. Third, in operation S504, geometric variable versus a transmission coefficient and a phase profile are determined while designing a unit structure. Fourth, in operation S506, phase distribution of the wavefront on an observation plane from a radiation source is identified and phase compensation distribution of a metasurface lens is calculated to generate a target radiation beam pattern corresponding to an output of a metamaterial structure surface.

Fifth, in operation S508, a focal length to aperture ratio f/D is optimized to maximize antenna gain, in operation S510, continuous phase compensation distribution acquired through mathematical calculations is discretized (into a grid including pixels) and geometric parameters for each unit cell are optimized to achieve the required phase for each segment, and in operation S512, it is determined whether the optimization is performed.

Sixth, in operation S514, an angle of a beam based on a phase for beam steering of a transmitarray antenna is changed. Seventh, in operation S516, a patch for each steering angle corresponding to a position of each element of a radiation source arrangement is selected and a level of electromagnetic wave phase compensation between the patch and a surface is identified. Eighth, in operation S518, through the EM simulation of the entire structure, including detailed electromagnetic analysis of the selected radiation source and the metamaterial structure surface, the radiation beam pattern corresponding to the output of a metalens is acquired to identify beam steering characteristics and gain.

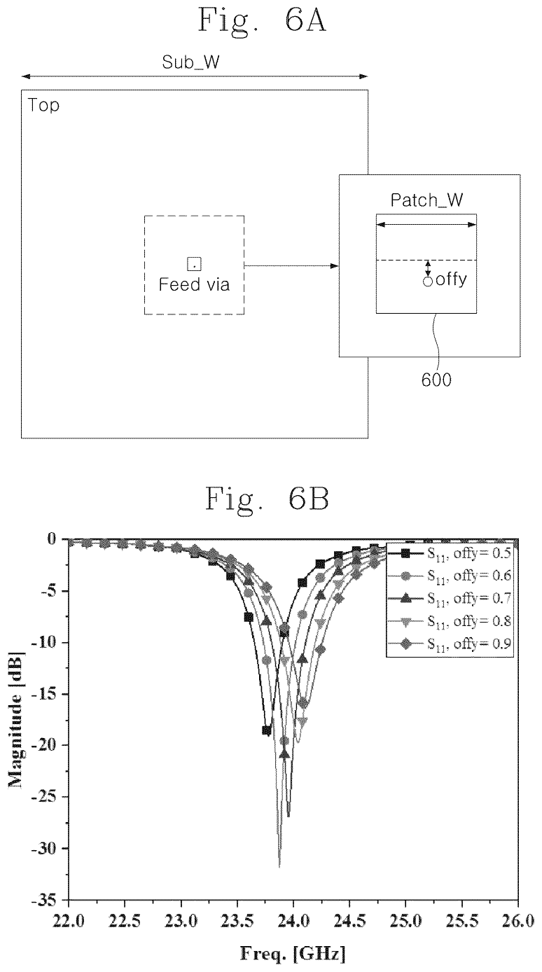

FIG. 6A illustrates a representative appearance of a radiating element of a device according to a new concept suggested by the present disclosure, the device determining a beam steering angle of a transmitarray antenna by selecting one patch 600 from an array of radiation sources. FIG. 6B illustrates return loss (S11), and FIG. 6C illustrates the beam-pattern observed on different Φ-planes. A horn antenna may be used, but it would be bulky and heavy, and a long distance, required as a precondition, to the metamaterial lens would make the entire antenna structure heavy, so for low cost and practicality, a patch antenna is used as the radiating element.

Referring to FIGS. 6B and 6C, an input port return loss (S11) of the patch antenna shows that a portion corresponding to a dip indicates a target frequency, indicating a resonance phenomenon, which, at this point, generates a wide beam with a 5 dBi gain as seen in the two-dimensional rectangular plot. Although the wide beam has a low gain, the wide beam is directed to the desired steering angle with high gain after passing through the metasurface lens 202.

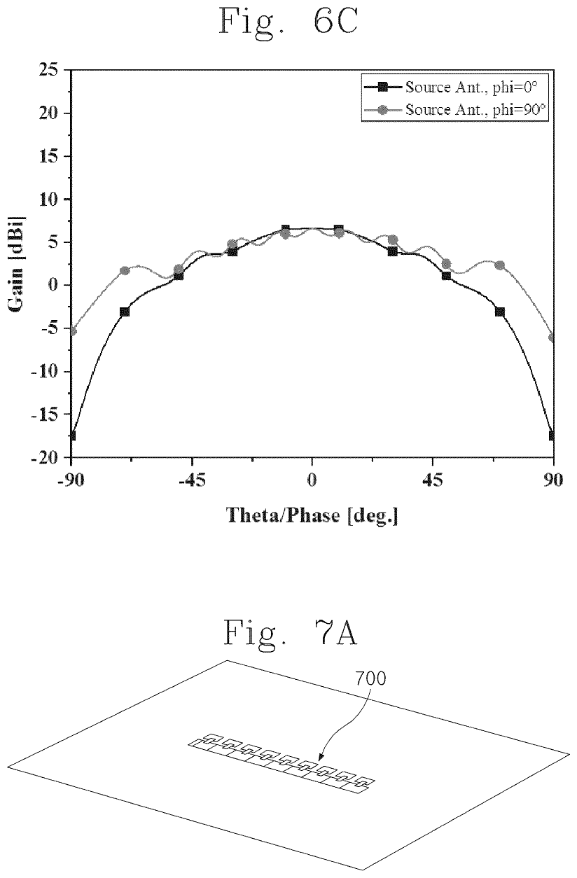

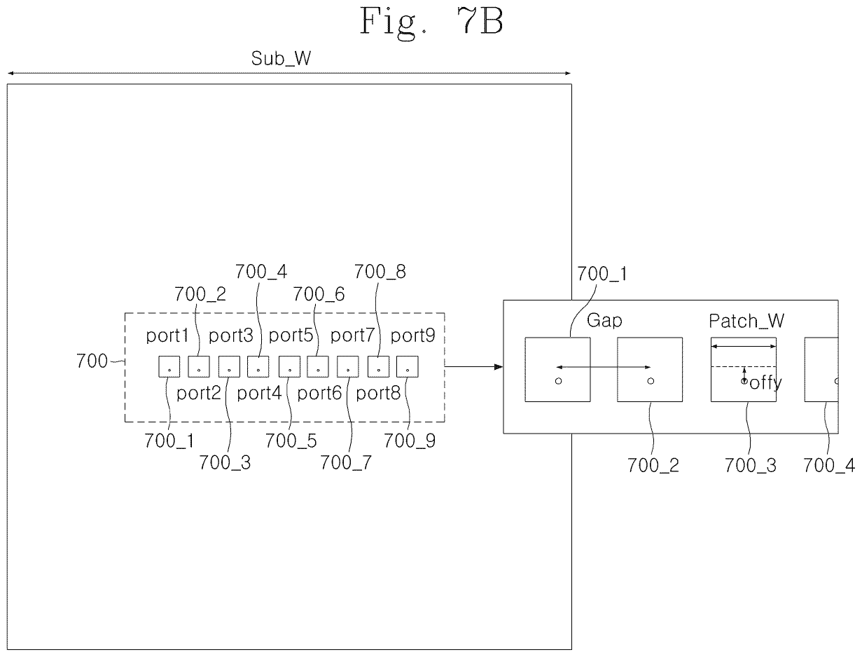

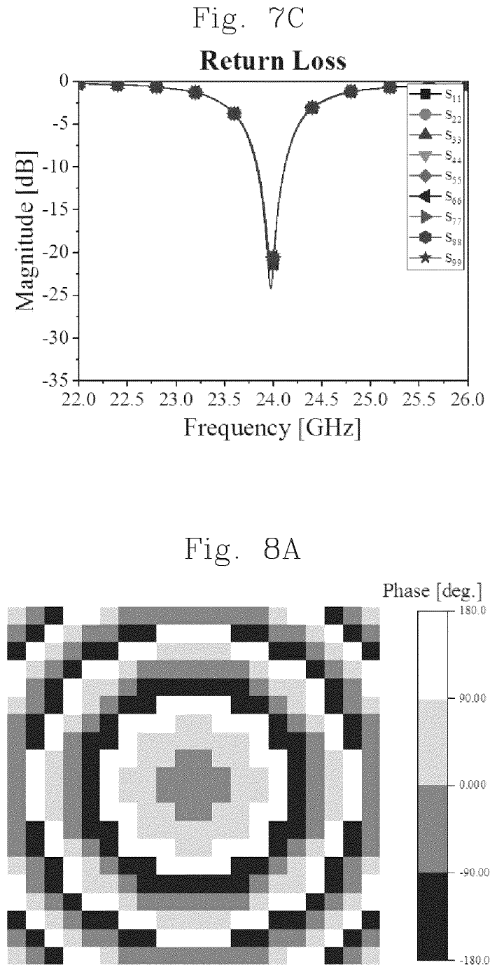

FIGS. 7A and 7B illustrate one radiation source of FIG. 6A arranged in one dimension. It is important to note that this array 700 is not a conventional array antenna including a power divider on a surface together with patches or below thereof or array antenna elements having a phase difference relationship based on a steering angle input, but radiating patches 700_1 to 700_9, that are independently operating radiating sources. FIG. 7C illustrates return loss (S11). The radiating patches 700_1 to 700_9 are simple RF switch connection feeds rather than millimeter wave power divider with increased dielectric substrate loss and metal transmission line loss. Depending on a location of a radiation source patch, the final steering angle of the radiated beam is changed. As shown in FIG. 7C, it may be identified that the operating frequency is generated uniformly at each port of the array elements through the input-port reflection coefficient.

FIG. 8A illustrates a discretization of phase compensation distribution configured to compensate for the phase of a wide beam of the radiation source, observed on the bottom surface of the metamaterial structure for high gain and beam steering.

FIG. 8B illustrates a structure of one layer of a multi-layer unit cell structure 803 and FIG. 8C illustrates a multi-layer unit cell structure 803 configured in three layers 810, 812, and 814. This structure allows for determination of the necessary phase for each unit cell, that is, pixel, of the metamaterial structure, increases design flexibility through increasing design variables by employing a new structure that combines a modified circular patch 804 within a metal ring 802 and replicates the structure 811, 813, or 815 in which a modified circular patch 804 within a metal ring 802 is combined within the metal ring 802 throughout the three layers 810, 812, and 814, and allows for the desired phase per pixel to be achieved with fewer layers through concurrent operation of L and C by combining an inductance of the ring 802 and a capacitance of the circular patch 804, showing an advantage in preventing millimeter-wave signal attenuation and bandwidth narrowing. In an embodiment of the present disclosure, the multi-layer unit cell structure 803 is configured to have three layers, but the present disclosure is not limited thereto and may be configured to have fewer or more layers.

In addition, referring to FIGS. 8B and 8C, the single-layer unit cell structure 800 and the multi-layer unit cell structure 803 have a point symmetric structure that is less susceptible to polarization in both transmission and reception wave and allows good transmission and reception. By adjusting geometric parameters such as a diameter R1 of the modified circular patch 804, a size of the ring 802, a gap corresponding to a distance between the modified circular patch 804 and the ring 802, and a filling ratio corresponding to an area ratio of the circular patch 804 to the ring 802, a magnitude of a transmission coefficient (a transmission coefficient S21 in a state in which the bottom of a pixel is configured as an input port and the top of the pixel is configured as an output port) is maximized to primarily increase the phase, and as passing through each layer, the phase reaches the desired phase for a single pixel. FIG. 8D illustrates transmission loss, and FIG. 8E illustrates a transmission phase. FIG. 8F illustrates a diameter R1 of a circular patch which is a geometric variable versus pixel transmission coefficient, that is, a transmission coefficient phase profile. Dimensions are determined through this graph. That is, the phase to be compensated for is determined according to at least one of a diameter R1 of the circular patch 804 and a gap corresponding to a separation distance between the metal ring 802 and the circular patch 804. FIG. 8G illustrates a metamaterial flat lens 820 implemented to have a specialized pattern, such as a checkerboard or compound eye of a dragonfly by arranging the pixel structures 803.

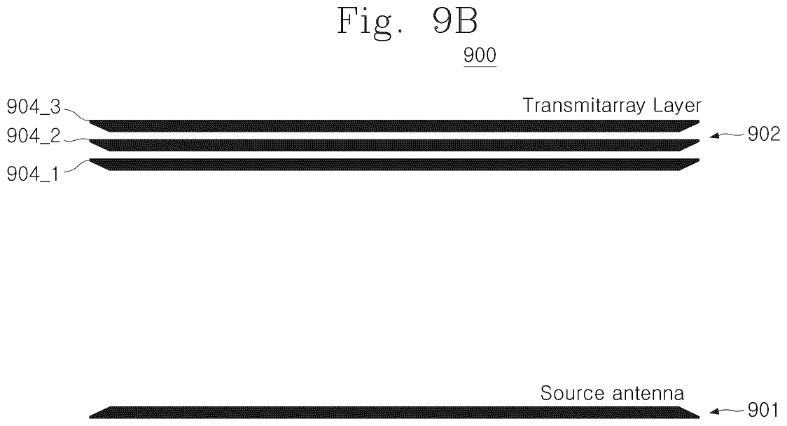

FIGS. 9A and 9B illustrate a structure 900 in which a metamaterial structure lens 902 having a holographic surface shown in FIG. 8G is integrated with a radiation source array layer 901. In an embodiment of the disclosure, the metamaterial flat lens 902 is configured to have three layers 904_1, 904_2, and 904_3, but the present disclosure is not limited thereto and may be configured to have fewer or more layers.

Referring to the structure 900 in which the metamaterial structure lens 902 is integrated with the radiation source array layer 901 shown in FIGS. 9A and 9B, the structure has a significantly simpler feed network than array antennas of the same diameter, and addresses both an electromagnetic loss problem of a power dividers and a problem of chipset active phase shifters in an array antenna.

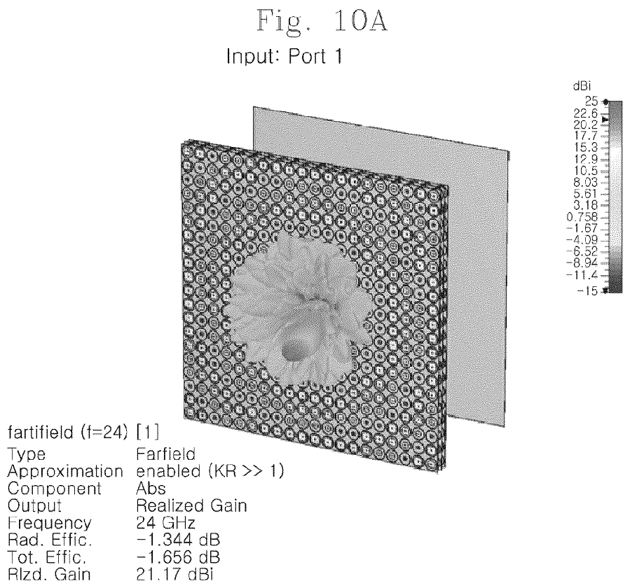

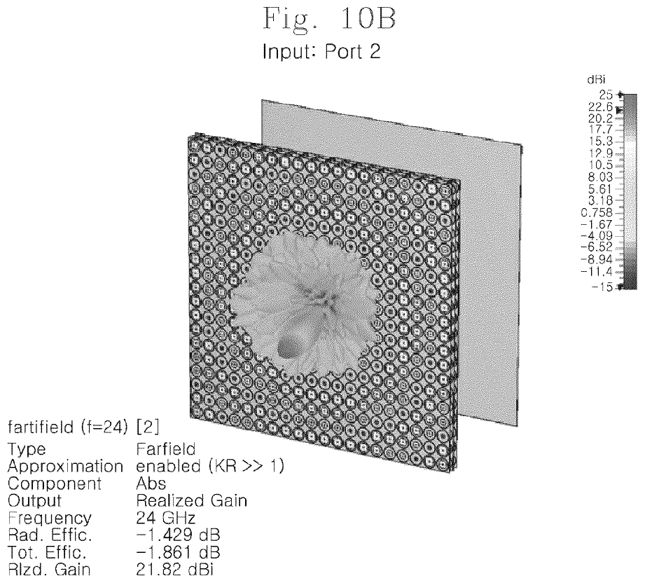

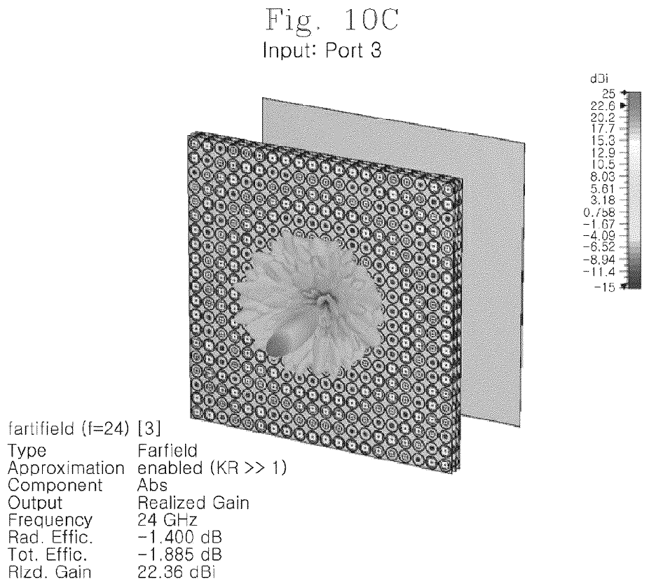

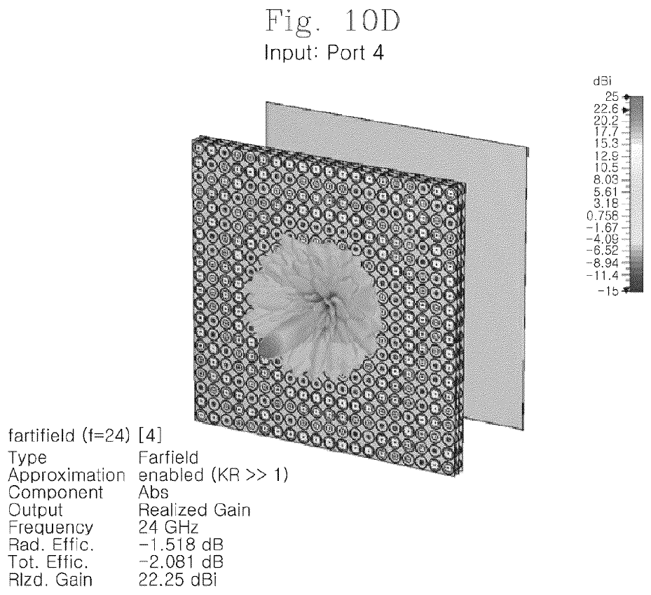

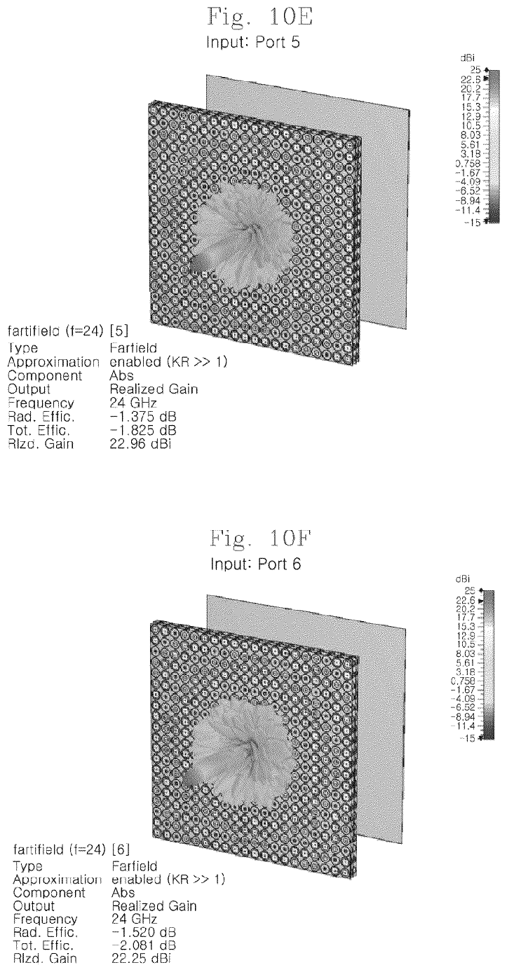

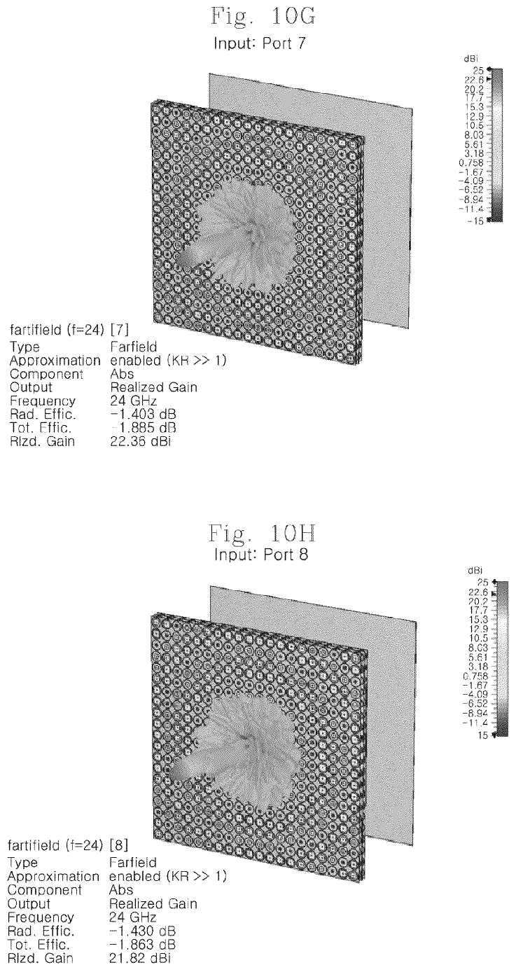

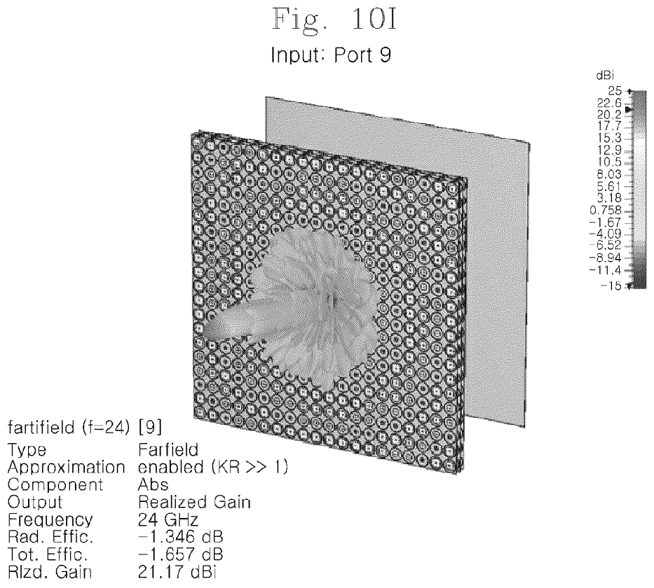

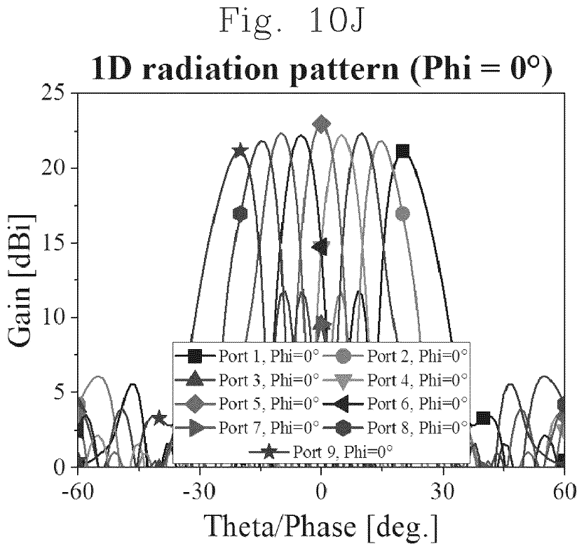

FIGS. 10A to 10I are views illustrating electromagnetic characteristics of the structure 900 in which the metamaterial flat lens 902 is integrated with the radiation source array layer 901 shown in FIGS. 9A and 9B and advantages of the present disclosure. Port 1 denotes that patch 1 is selected, Port 2 denotes that patch 2 is selected, . . . , and Port 9 denotes that patch 9 is selected. As shown in FIG. 10A, it is identified that when Port 1 is selected, a radiation beam directs to the right, as shown in a three-dimensional radiation pattern and a two-dimensional rectangular plot of the radiation pattern. Furthermore, as shown in FIGS. 10B to 10I, by selecting a radiation source from Port 2 to Port 9, a direction of a beam is adjusted while maintaining high gain characteristics. FIG. 10J is a view illustrating a one-dimensional radiation pattern. The features of the present disclosure will tackle disadvantages of the traditional mechanically steered antennas or phased array antennas.

The present disclosure is not limited by the above-described embodiments and the accompanying drawings. For those of ordinary skill in the art to which the present disclosure pertains, it will be apparent that the components according to the present disclosure can be substituted, modified, and changed without departing from the technical spirit of the present disclosure.

1. A metasurface flat lens-type beamforming antenna for radars and communication, capable of adjusting an electromagnetic wave beam pointing angle by selecting an electromagnetic wave source, and requiring no chipset active phase shifters, the antenna comprising:
a radiation part comprising multiple radiating patches arranged in one dimension and spaced a predetermined distance apart from each other; and
a metamaterial flat lens which is disposed spaced a predetermined distance apart from the radiation part and on which single-layer or multi-layer unit cell structures configured to compensate for phases are arranged to match a phase compensation distribution for a high gain and steering of an incident wave having been radiated from one of the multiple radiating patches.

2. The antenna of claim 1, wherein the unit cell structures comprise:
a metal ring; and
a modified circular patch disposed inside the metal ring and spaced a predetermined distance apart from the metal ring.

3. The antenna of claim 2, wherein the modified circular patch comprises:
a first capacitance adjustment part acquired by making a hole at the central part of the circular patch; and
a second capacitance adjustment part acquired by making notches on the top, bottom, left, and right sides as the outer circumferential part of the circular patch, and
the circular patch is configured to have a point symmetric shape.

4. The antenna of claim 2, wherein the phase of the incident electromagnetic wave is compensated for by a combination of an inductance of the metal ring and a capacitance of the circular patch, and
when the incident electromagnetic wave passes through each layer of a multi-layer unit cell structure, the phase required for an individual cell is obtained.

5. The antenna of claim 2, wherein the phase to be compensated for is determined according to at least one of a diameter of the circular patch and a gap corresponding to a separation distance between the metal ring and the circular patch.

6. The antenna of claim 1, further comprising a switch configured to provide an incident electromagnetic wave to one of the multiple radiating patches.

7. The antenna of claim 6, further comprising a switch controller configured to control operation of the switch.

8. The antenna of claim 1, wherein the unit cell structures configured to have multiple layers are configured by stacking multiple single-layer unit cells having an identical structure of multiple layers.

9. A metamaterial flat lens comprising single-layer or multi-layer unit cell structures configured to compensate for a phase for a high gain and steering of an incident wave,
wherein the single-layer or multi-layer unit cell structures are arranged to match a phase compensation distribution.

10. The lens of claim 9, wherein the unit cell structures comprise:
a metal ring; and
a modified circular patch disposed inside the metal ring and spaced a predetermined distance apart from the metal ring.

11. The lens of claim 10, wherein the modified circular patch comprises:
a first capacitance adjustment part acquired by making a hole at the central part of the circular patch; and
a second capacitance adjustment part acquired by making notches on the top, bottom, left, and right sides as the outer circumferential part of the circular patch, and
the circular patch is configured to have a point symmetric shape.

12. The lens of claim 10, wherein the phase of the incident electromagnetic wave is compensated for by a combination of an inductance of the metal ring and a capacitance of the circular patch, and
when the incident electromagnetic wave passes through each layer of a multi-layer unit cell structure, the phase required for an individual cell is obtained.

13. The lens of claim 10, wherein the phase to be compensated for is determined according to at least one of a diameter of the circular patch and a gap corresponding to a separation distance between the metal ring and the circular patch.

14. The lens of claim 9, wherein the unit cell structures configured to have multiple layers are configured by stacking multiple single-layer unit cells having an identical structure of multiple layers.

15. A unit cell structure for a metamaterial flat lens for a high gain and steering of an incident wave,
wherein the unit cell structure is configured to have a single layer or multiple layers and compensate for a phase for a high gain and steering of an incident wave.

16. The unit cell structure of claim 15, comprising:
a metal ring; and
a modified circular patch disposed inside the metal ring and spaced a predetermined distance apart from the metal ring.

17. The unit cell structure of claim 16, wherein the modified circular patch comprises:
a first capacitance adjustment part acquired by making a hole at the central part of the circular patch; and
a second capacitance adjustment part acquired by making notches on the top, bottom, left, and right sides as the outer circumferential part of the circular patch, and
the circular patch is configured to have a point symmetric shape.

18. The unit cell structure of claim 16, wherein a phase of an incident electromagnetic wave is compensated for by a combination of an inductance of the metal ring and a capacitance of the circular patch, and
when the incident electromagnetic wave passes through each layer of a multi-layer unit cell structure, the phase required for an individual cell is obtained.

19. The unit cell structure of claim 16, wherein the phase to be compensated for is determined according to at least one of a diameter of the circular patch and a gap corresponding to a separation distance between the metal ring and the circular patch.

20. The unit cell structure of claim 15, wherein the unit cell structure configured to have multiple layers is configured by stacking multiple single-layer unit cells having an identical structure of multiple layers.
